(19) United States
(12) Patent Application Publication
(10) Pub. No.: US 2015/0341833 A1
(43) Pub. Date: Nov. 26, 2015

(54) APPARATUS AND METHODS FOR AVOIDING UNNECESSARY CELL RESELECTIONS IN A WIRELESS COMMUNICATIONS NETWORK

(71) Applicant: QUALCOMM Incorporated, San Diego, CA (US)

(72) Inventors: Santhana Palanisamy, Hyderabad (IN); Kunal Tyagi, Hyderabad (IN); Manjunatha Subbamma Ananda, Hyderabad (IN); Daniel David Renji, Hyderabad (IN)

(73) Assignee: QUALCOMM Incorporated, San Diego, CA (US)

(21) Appl. No.: 14/286,472

(22) Filed: May 23, 2014

(51) Int. Cl. H04W 36/00

(52) U.S. Cl. CPC H04W 36/0083; H04W 36/34

(57) ABSTRACT

Aspects of the present disclosure are directed to cell reselection procedures that can mitigate adjacent channel interference (ACI) related problems in a wireless network. A mobile station (MS) determines a signal level quality for each of a plurality of cells including a serving cell and a plurality of neighbor cells. The MS further determines ACI in each of the plurality of cells in a same public land mobile network (PLMN). In addition, the MS performs a cell reselection procedure based on a respective signal level quality and ACI of the plurality of cells in the same PLMN.

### TECHNICAL FIELD

The technology discussed below relates generally to wireless communication systems, and more particularly, to cell reselection in a wireless communications network. Aspects of the technology enable and provide power-efficient devices and aid in selection of cellular resources for positive user experience.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is a Global System for Mobile Communications (GSM) network, which utilizes a GSM air interface. Enhanced GPRS (EGPRS) is an extension of GSM technology providing increased data rates beyond those available in second-generation GSM technology. EGPRS is also known in the field as Enhanced Data Rates for GSM Evolution (EDGE), and IMT Single Carrier.

A GSM network utilizes a broadcast mechanism for distributing information to multiple mobile devices (also called user equipment, access terminal, mobile station (MS), mobile terminal, access node, etc.). In a GSM network, a number of control channels are used, for example, including a Broadcast Control Channel (BCCH), a Common Control Channel (CCCH), and Dedicated Control Channels (DCCHs). The CCCH is used for transferring control information between mobile stations and a base station. For example, the CCCH includes a Paging Channel (PCH), which is used by the base station to page an MS when there is an incoming call addressed to the MS. A base station uses a PCH to call an individual MS within its current cell.

GSM communication systems can utilize various radio frequency (RF) bands for wireless communication. The basic service area in a GSM system is called a cell, which is covered by a base station such as a base transceiver station (BTS). In general, each cell can have one to three sectors. GSM frequencies (or carriers) are specified by absolute radio-frequency channel numbers (ARFCNs). The number of ARFCNs available to a network operator is generally limited, and thus, network operators re-use the available ARFCNs for a certain GSM coverage. Network planning should be configured to reduce interference from one cell to another by avoiding using adjacent ARFCNs among neighboring cells.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure are directed to cell reselection procedures that can mitigate adjacent channel interference (ACI) related problems in a wireless network.

An aspect of the disclosure provides a method of wireless communication operable at a mobile station (MS). The MS determines a signal level quality for each of a plurality of cells including a serving cell and a plurality of neighbor cells. The MS further determines adjacent channel interference (ACI) in each of the plurality of cells in a same public land mobile network (PLMN). In addition, the MS performs a cell reselection procedure based on a respective signal level quality and ACI of the plurality of cells in the same PLMN.

Another aspect of the disclosure provides a mobile station (MS). The MS includes a signal level quality determination component configured to determine a signal level quality for each of a plurality of cells including a serving cell and a plurality of neighbor cells. The MS further includes an adjacent channel interference (ACI) determination component configured to determine ACI in each of the plurality of cells in a same PLMN. The MS further includes a cell reselection determination component configured to perform a cell reselection procedure based on a respective signal level quality and ACI of the plurality of cells in the same PLMN.

Another aspect of the disclosure provides a mobile station (MS). The MS includes means for determining a signal level quality for each of a plurality of cells including a serving cell and a plurality of neighbor cells. The MS further includes means for determining adjacent channel interference (ACI) in each of the plurality of cells in a same PLMN. The MS further includes means for performing a cell reselection procedure based on a respective signal level quality and ACI of the plurality of cells in the same PLMN.

Another aspect of the disclosure provides a computer-readable medium including code for causing a mobile station (MS) to perform various functions. The code causes the MS to determine a signal level quality for each of a plurality of cells including a serving cell and a plurality of neighbor cells. The code further causes the MS to determine adjacent channel interference (ACI) in each of the plurality of cells in a same PLMN. The code further causes the MS to perform a cell reselection procedure based on a respective signal level quality and ACI of the plurality of cells in the same PLMN.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In a similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram conceptually illustrating an example of a telecommunications system according to some aspects of the disclosure.

FIG. 2 is a conceptual diagram illustrating an example of an access network according to some aspects of the disclosure.

FIG. 3 is a conceptual diagram illustrating a channel configuration for control channels in a GSM multiframe.

FIG. 4 is a diagram illustrating a cell reselection procedure in accordance with aspects of the disclosure.

FIG. 5 is a diagram illustrating a number of tasks performed by a mobile station (MS) while camped on a serving cell.

FIG. 6 is a diagram illustrating a cell reselection procedure in accordance with aspects of the disclosure.

FIG. 7 is a diagram illustrating a cell reselection procedure for reducing unnecessary cell reselection in accordance with aspects of the disclosure.

FIG. 8 is a diagram illustrating a cell reselection procedure for reducing unnecessary cell reselection in accordance with aspects of the disclosure.

FIG. 9 is a conceptual block diagram illustrating an MS configured to reduce unnecessary cell reselection in accordance with an aspect of the disclosure.

FIG. 10 is a block diagram illustrating an example of a hardware implementation for an apparatus employing a processing system in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Aspects of the present disclosure are directed to cell reselection procedures that can mitigate adjacent channel interference (ACI) related problems in a wireless network. Interference can appear in the form of co-channel interference when carriers of two neighboring cells/sectors have the same frequency. Interference can also be caused by ACI when adjacent channels (e.g., ARFCNs) are present in the same cell or in neighboring cells, with a power difference less than about a certain value (e.g., 9 dBm). For example, some aspects of the disclosure may mitigate ACI related cell reselection problems in C2-based cell reselection and non-C2 based cell reselection. In C2-based cell reselection, the determination of a better cell is made based on a path loss criterion parameter C2. This parameter is defined in a document, Third Generation Partnership Project (3GPP) Technical Specification (TS) 05.08, section 6.4, version 8.23.0, which is incorporated herein by reference. Cell reselection to a better cell is referred to as C2-based cell reselection because the better cell is determined based on the parameter C2 for the better cell (target cell) and the current serving cell. If cell reselection is triggered by an event other than a better cell being found, it is referred to as a non-C2 based cell reselection.

Due to inadequate RF planning, in some GSM networks or similar networks, at a given site there could be two or more adjacent channels (for example ARFCNs 51 and 52) having receive signal level less than or up to 10 dBm in difference, which may affect RF conditions of the serving cell and the target cell (neighbor cell) of the same public land mobile network (PLMN) during cell reselection. Because of this type of adjacent channel implementation, certain problems can arise at the serving cell and/or the target cell. At the serving cell, an MS may experience significant or continuous control channel (e.g., BCCH, CCCH, and/or DCCH) decoding failures that can lead to a downlink signaling failure (DSF). As a result of DSF, cell reselection will be triggered, and in the worst case, the MS may reselect to a target cell that is also affected by ACI. At the target cell affected by ACI, the C2-based reselection to any of the ARFCNs of the target cell may fail due to channel interference, and because of that, an undesirable power scan will be triggered. During the power scan, the MS is unable to receive or originate calls.

In some aspects of the disclosure, if an MS is camped on a serving cell that is in a satisfactory RF condition (e.g., MS can decode the PCH), the MS is configured not to reselect to a target cell that is affected by ACI. In some aspects of the disclosure, if the MS is camped on a serving cell that is fading and there are better neighbor cells (i.e., neighbor cells with better signal level quality), including neighbor cells that utilize adjacent channels (e.g., ARFCNs adjacent to those of the serving cell), then the MS is configured to avoid reselection to a neighbor cell with an adjacent channel. Instead, the MS reselects to the best available cell that does not utilize an adjacent channel and has a greater C2 value than that of the serving cell. However, if there is no available better neighbor cell (i.e., a cell with a greater C2 value than that of the serving cell) that does not deploy an adjacent channel, the MS is configured to perform a power scan on the frequencies or ARFCNs to find a target cell that is not affected by ACI. If the power scan fails to find a better target cell, the MS is configured to perform a complete scan on all the supported frequency bands to find any other available better target cells.

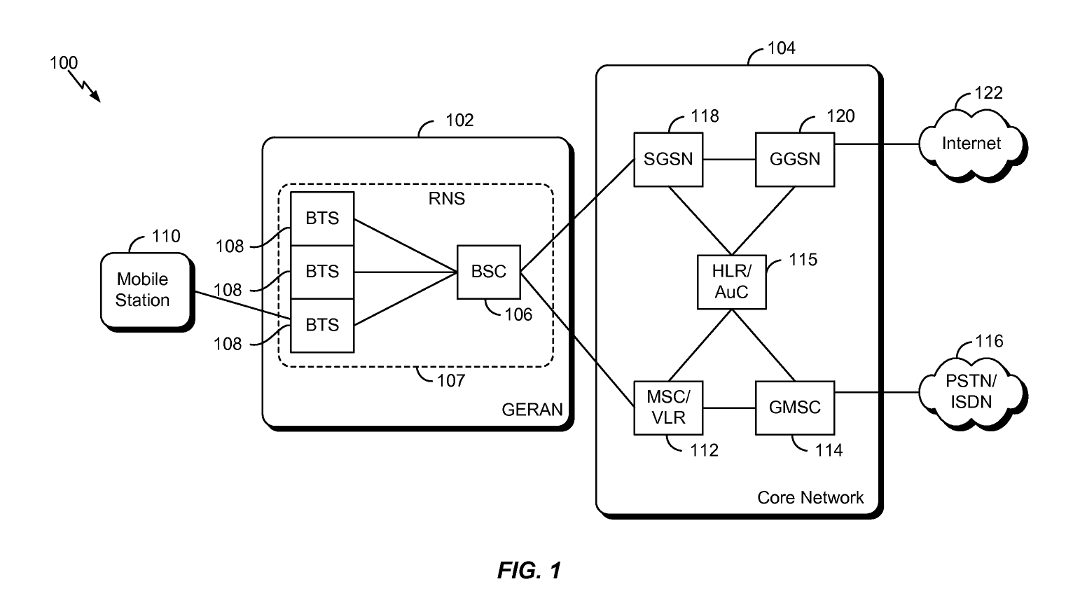

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a GSM system 100. A GSM network includes three interacting domains: a core network 104 (e.g., a GSM/GPRS core network), a radio access network (RAN) (e.g., the GSM/EDGE Radio Access Network (GERAN) 102), and mobile station (MS) 110. In this example, the illustrated GERAN 102 may employ a GSM air interface for enabling various wireless services including telephony, video, data, messaging, broadcasts, and/or other services. The GERAN 102 may include a plurality of Radio Network Subsystems (RNSs) such as an RNS 107, each controlled by a respective Base Station Controller (BSC) such as a BSC 106. Here, the GERAN 102 may include any number of BSCs 106 and RNSs 107 in addition to the illustrated BSCs 106 and RNSs 107. The BSC 106 is an apparatus responsible for, among other things, assigning, reconfiguring, and releasing radio resources within the RNS 107.

The geographic region covered by the RNS 107 may be divided into a number of cells, with a radio transceiver apparatus serving each cell. A radio transceiver apparatus is commonly referred to as a base transceiver station (BTS) in GSM applications, but may also be referred to by those skilled in the art as a base station (BS), a Node B, a radio base station, a radio transceiver, a transceiver function, a basic service set (BSS), an extended service set (ESS), an access point (AP), or some other suitable terminology. For clarity, three BTSs 108 are shown in the illustrated RNS 107; however, the RNSs 107 may include any number of wireless BTSs 108. The BTSs 108 provide wireless access points to a GSM/GPRS core network 104 for any number of mobile stations. Examples of a mobile station include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a network-connected device, or any other similar functioning devices. The mobile station is commonly referred to as user equipment (UE) in UMTS applications, but may also be referred to by those skilled in the art as a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The GSM “Um” air interface generally utilizes GMSK modulation (although later enhancements such as EGPRS, described below, may utilize other modulation such as 8PSK), combining frequency hopping transmissions with time division multiple access (TDMA), which divides a frame into 8 time slots. Further, frequency division duplexing (FDD) divides uplink and downlink transmissions using a different carrier frequency for the uplink than that used for the downlink. Those skilled in the art will recognize that although various examples described herein may refer to GSM Um air interface, the underlying principles are equally applicable to any other suitable air interfaces.

In some aspects of the disclosure, the GSM system 100 may be further configured for enhanced GPRS (EGPRS). EGPRS is an extension of GSM technology providing increased data rates beyond those available in 2G GSM technology. EGPRS is also known in the field as Enhanced Data rates for GSM Evolution (EDGE), and IMT Single Carrier. Specific examples are provided below with reference to the GSM system 100. However, the concepts disclosed in various aspects of the disclosure can be applied to any wireless communications system, such as but not limited to a UMTS system or an e-UTRA system using an LTE air interface.

For illustrative purposes, one MS 110 is shown in communication with one BTS 108 in FIG. 1. The downlink (DL), also called the forward link, refers to the communication link from a BTS 108 to an MS 110, and the uplink (UL), also called the reverse link, refers to the communication link from the MS 110 to the BTS 108.

The core network 104 can interface with one or more access networks, such as the GERAN 102. As shown, the core network 104 is a GSM core network. However, as those skilled in the art will recognize, the various concepts presented throughout this disclosure may be implemented in a RAN, or other suitable access network, to provide an MS with access to types of core networks other than GSM networks.

The illustrated GSM core network 104 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 104 supports circuit-switched services with an MSC 112 and a GMSC 114. In some applications, the GMSC 114 may be referred to as a media gateway (MGW). One or more BSCs, such as the BSC 106, may be connected to the MSC 112. The MSC 112 is an apparatus that controls call setup, call routing, and MS mobility functions. The MSC 112 also includes a visitor location register (VLR) that contains subscriber-related information for the duration that an MS is in the coverage area of the MSC 112. The GMSC 114 provides a gateway through the MSC 112 for the MS to access a circuit-switched network 116. The GMSC 114 includes a home location register (HLR) 115 containing subscriber data, such as the data reflecting the details of the services to which a particular user has subscribed. The HLR is also associated with an authentication center (AuC) that contains subscriber-specific authentication data. When a call is received for a particular MS, the GMSC 114 queries the HLR 115 to determine the location of the MS and forwards the call to the particular MSC serving that location.

The illustrated core network 104 also supports packet-switched data services with a serving GPRS support node (SGSN) 118 and a gateway GPRS support node (GGSN) 120. General Packet Radio Service (GPRS) is designed to provide packet-data services at speeds higher than those available with standard circuit-switched data services. The GGSN 120 provides a connection for the GERAN 102 to a packet-based network 122. The packet-based network 122 may be the Internet, a private data network, or some other suitable packet-based networks. The primary function of the GGSN 120 is to provide the MS 110 with packet-based network connectivity. Data packets may be transferred between the GGSN 120 and the MS 110 through the SGSN 118, which performs primarily the same functions in the packet-based domain as the MSC 112 performs in the circuit-switched domain.

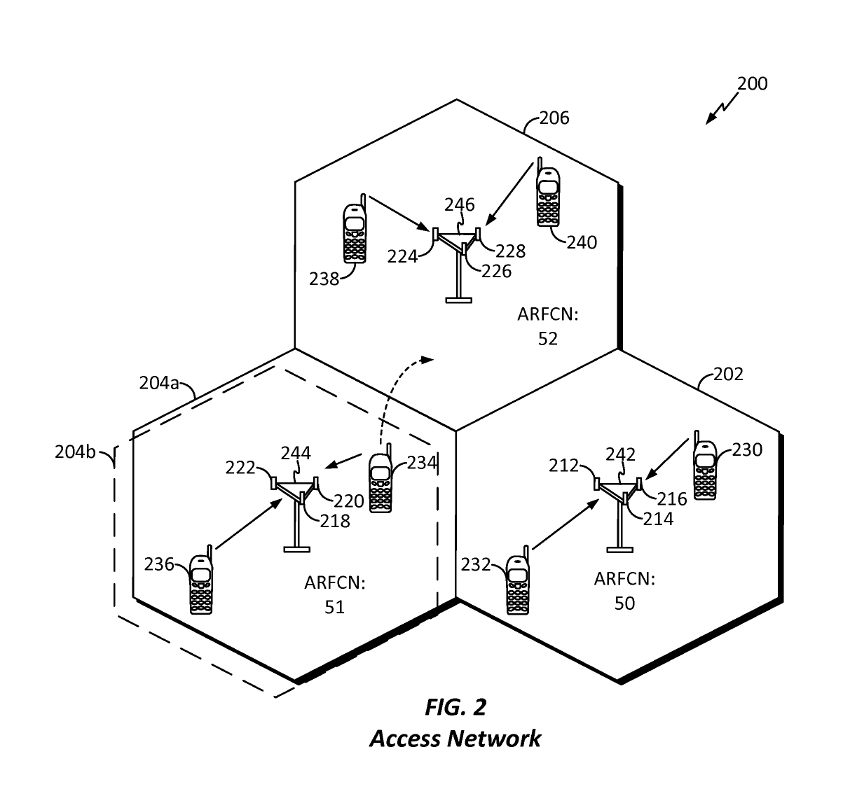

The GERAN 102 is one example of a RAN that may be utilized in accordance with the present disclosure. Referring to FIG. 2, by way of example and without limitation, a simplified schematic illustration of a RAN 200 in a GERAN architecture is illustrated. The system includes multiple cellular regions (cells), including cells 202, 204, and 206, each of which may include one or more sectors. The cells may belong to the same public land mobile network (PLMN), and each operator providing mobile services has its own PLMN. Cells may be defined geographically, e.g., by coverage area. In a cell that is divided into sectors, the multiple sectors within a cell can be formed by groups of antennas with each antenna responsible for communication with mobile stations in a portion of the cell. For example, in cell 202, antenna groups 212, 214, and 216 may each correspond to a different sector. In cell 204, antenna groups 218, 220, and 222 may each correspond to a different sector. In cell 206, antenna groups 224, 226, and 228 may each correspond to a different sector.

The cells 202, 204, and 206 may include several mobile stations that may be in communication with one or more sectors of each cell 202, 204, or 206. For example, MS 230 and MS 232 may be in communication with a BTS 242, MS 234 and MS 236 may be in communication with a BTS 244, and MS 238 and MS 240 may be in communication with a BTS 246. Here, each BTS 242, 244, and 246 may be configured to provide an access point to a core network 104 (see FIG. 1) for all the MSs 230, 232, 234, 236, 238, and 240 in the respective cells 202, 204, and 206. In the GERAN 102, each of the cells or sectors is configured to communicate with the mobile stations with its assigned radio carriers or ARFCNs. However, in some network implementations, two neighbor cells may be assigned with adjacent ARFCNs, which may cause undesirable ACI. For example, the cells 202, 204, and 206 may be assigned with adjacent ARFCNs 50, 51, and 52, respectively. In this case, an MS may experience ACI depending on its location among the cells 202, 204, and 206.

During a call with a source cell, or at any other time, for example, an MS 236 may monitor various parameters of the source cell as well as various parameters of neighboring cells. For example, an MS 236 may monitor the C2 parameter of its serving cell and neighbor cells. Further, depending on the quality of these parameters, the MS 236 may maintain communication with one or more of the neighboring cells, or initiate cell reselection. During this time, the MS 236 may maintain an Active Set, that is, a list of cells to which the MS 236 is simultaneously connected.

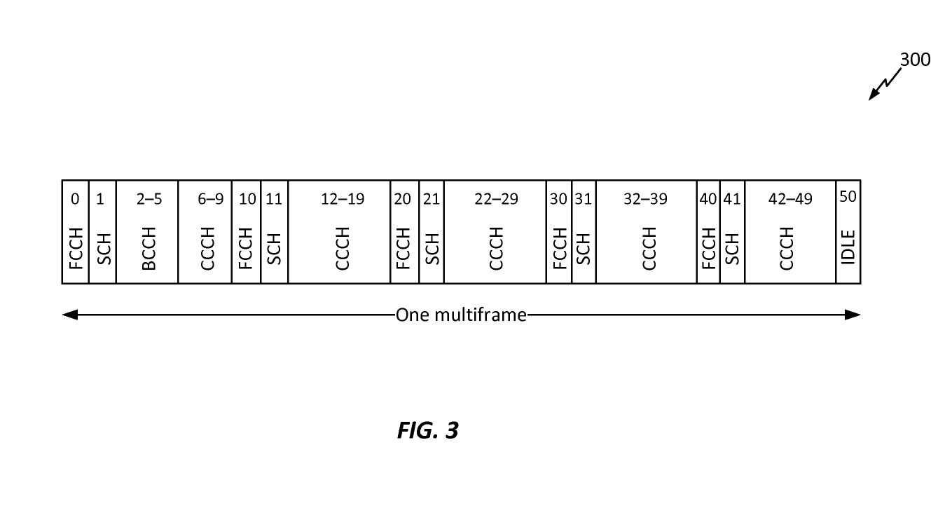

FIG. 3 is a conceptual diagram illustrating a channel configuration for the control channels in a GSM multiframe 300. Each GSM multiframe is partitioned into 51 TDMA frames, which are labeled as frames 0 through 50 in FIG. 3. Each frame is further partitioned into 8 time slots (not shown), which are time slots 0 through 7. In general, control channels may utilize time slot 0, and traffic channels may utilize time slots 1 through 7. The data transmission in each time slot is referred to as a “burst.”

The GSM control channels include, for example, a frequency correction channel (FCCH), a synchronization channel (SCH), a broadcast control channel (BCCH), and a common control channel (CCCH). The FCCH is sent in frames 0, 10, 20, 30 and 40 of each multiframe, and is used for setting MS frequency and timing. The SCH is sent in frames 1, 11, 21, 31 and 41 of each multiframe, and is used for synchronizing MS timing and frame numbering with a base station. The BCCH is sent in frames 2, 3, 4 and 5 of each multiframe and carries system information. The CCCH carries control information such as a paging channel (PCH). The PCH carries paging messages that alert an MS on incoming calls. In a poor signal quality condition, such as ACI, the MS may not be able to decode the PCH at a certain site. The multiframe 300 shows one configuration for the control channels. However, the present disclosure is not limited to the multiframe 300, and other combinations of control channels for the 51-frame multiframe may be used. For example, other valid channel configurations for the control channels in GSM are described in detail in a document 3GPP TS 05.01, version 8.9.0, which is incorporated herein by reference.

Each cell (e.g., cells 202, 204, and 206 of FIG. 2) may broadcast system information on one or more of the RF carriers (identified by ARFCNs) assigned to the cell. For example, a carrier used for broadcasting system information may be the BCCH carrier. Each cell broadcasts a BCCH allocation (BA) list that can include up to 32 ARFCNs for the BCCH carriers of up to 32 cells. That is the BA list includes one ARFCN/BCCH carrier entry for each cell. The BA lists respectively broadcast by neighbor cells located near each other are typically not identical, but may include many of the same ARFCNs. An MS receives the BA list from its serving cell and performs measurements on the cells included in the BA list, as specified by the GSM standards.

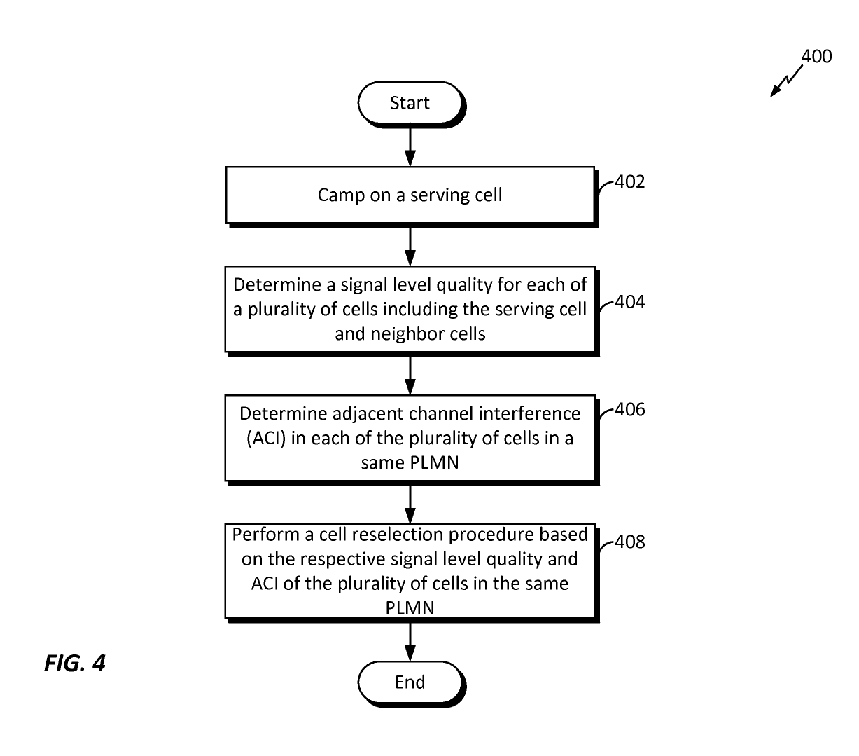

FIG. 4 is a diagram illustrating a cell reselection procedure 400 in accordance with aspects of the disclosure. For example, the cell reselection procedure 400 may be performed by any MS illustrated in FIGS. 1, 2, 9, and/or 10 at any of the cells illustrated in FIGS. 1 and/or 2. In one aspect of the disclosure, an MS 236 may perform the procedure 400.

At block 402, when an MS is powered on, it performs cell selection and searches for a suitable serving cell from which it may receive communication service. When a suitable cell is found, the MS camps on this cell, which becomes the serving cell. For example, the serving cell may be a cell 204 of FIG. 2. During idle while camped on the serving cell, the MS may perform a number of tasks. At block 404, for example, the MS determines the signal level quality (or channel quality) of a number of cells including the serving cell and neighbor cells (non-serving cells). For example, the MS may determine the respective signal level quality of the ARFCNs assigned to the cells.

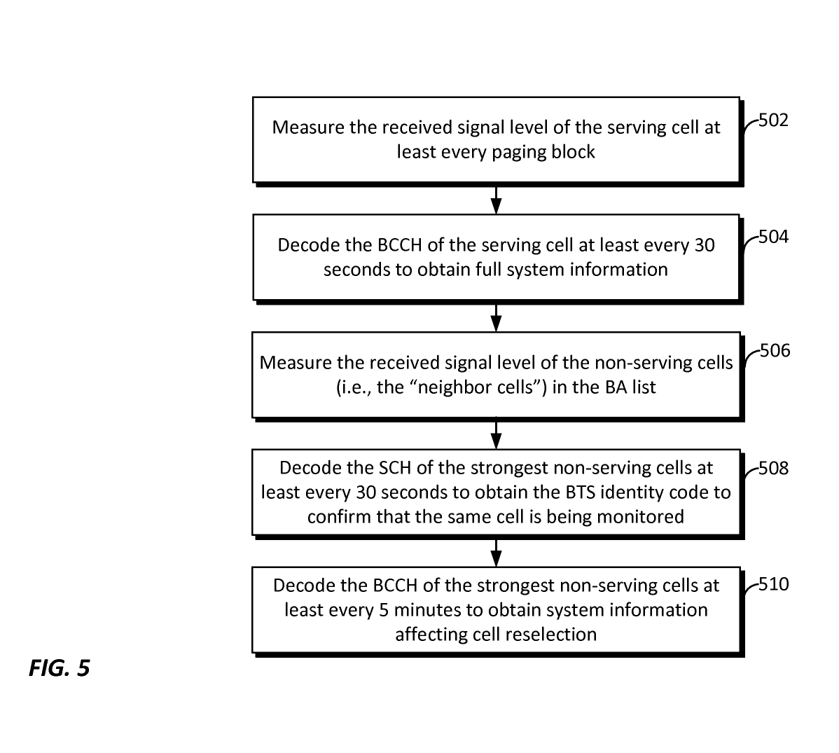

FIG. 5 is a diagram illustrating a number of task that may be performed by an MS during idle. At block 502, the MS may measure the received signal level of the serving cell at least every paging block. At block 504, the MS may decode the BCCH of the serving cell, for example, at least every 30 seconds to obtain full system information. At block 506, the MS may measure the received signal level of the non-serving cells (i.e., the “neighbor cells”) in the BA list. At block 508, the MS may decode the SCH of the strongest non-serving cells (e.g., six strongest cells), for example, at least every 30 seconds to obtain the BTS identity code to confirm that the same cell is being monitored. At block 510, the MS may decode the BCCH of the strongest non-serving cells at least every 5 minutes to obtain system information affecting cell reselection. The tasks illustrated in FIG. 5 are not exhaustive of tasks performed by the MS and may be performed in different orders in sequence and/or simultaneously. For example, other tasks or measurements that may be performed by the MS while camped on a cell are described in the document 3GPP TS 05.08, section 6.6.1, version 8.23.0, which is incorporated herein by reference.

Referring back to FIG. 4, at block 404, the MS determines a signal level quality for each of a plurality of cells (e.g., cells 202, 204, and 206 of FIG. 2) including the serving cell and a number of neighbor cells. For example, the MS may determine the respective signal level quality of the ARFCNs assigned to the cells. The MS may use the downlink RSSI (Received Signal Strength Indicator) to determine the signal level quality of the ARFCNs. RSSI indicates the measured power of a received radio signal, and the received power can be calculated from the RSSI of each ARFCN. At block 406, the MS determines the ACI in each of the plurality of cells in a same public land mobile network (PLMN). For example, the MS may determine the ACI based on a difference in signal level quality between an ARFCN of a certain cell and an adjacent ARFCN. At block 408, the MS performs a cell reselection procedure based on the respective signal level quality and ACI of the plurality of cells in the same PLMN.

While camped on the serving cell, the MS uses the measurements on the serving cell and neighbor cells and system information received from the cells, to determine whether there is a better cell (i.e., a cell with better signal level quality) that the MS can camp on and receive service (e.g., C2-based reselection), or to select another serving cell if the MS cannot remain camped on the current serving cell (e.g., non-C2 based reselection). The MS makes periodic determination on whether or not cell reselection should be performed. In various aspects of the disclosure, the MS may perform cell reselection to select a new serving cell under a number of conditions, which will be described in detail below.

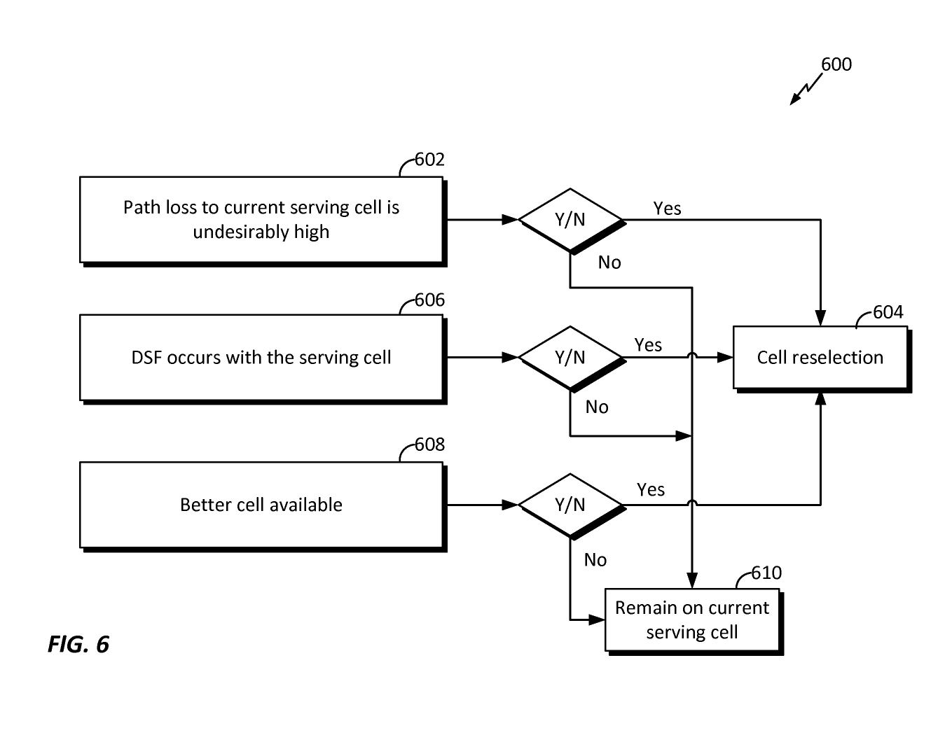

FIG. 6 is a diagram illustrating a cell reselection procedure 600 in accordance with aspects of the disclosure. For example, the reselection procedure 600 may be performed by any MS illustrated in FIGS. 1, 2, 9, and/or 10 at any of the cells illustrated in FIGS. 1 and/or 2. In one aspect of the disclosure, the MS may be an MS 236 of FIG. 2. In an example, the cell reselection procedure 600 may be performed at block 408 of FIG. 4. At block 602, if the MS determines that the path loss to the current serving cell is undesirably high, the procedure proceeds to cell reselection block 604. At block 606, if the MS determines that DSF occurs with the serving cell, the procedure proceeds to cell reselection block 604. At block 608, if the MS determines that a better cell is available (e.g., based on C2 values of the cells), the procedure proceeds to cell reselection block 604. The cell reselection block 604 will be described in detail below. Otherwise, at block 610, the MS remains camped on the current serving cell. The reselection scenarios of FIG. 6 are not exhaustive. In other aspects of the disclosure, the MS may perform cell reselection in other scenarios.

At block 602, the path loss to a cell may be determined based on a path loss criterion parameter C1. The parameter C1 can be a function of received signal strength measurements and other parameters for the cell. The path loss is excessively or undesirably high if the C1 value is less than zero for at least five seconds. The parameter C1, which is known in the art, is described, for example, in the document 3GPP TS 05.08, section 6.4, version 8.23.0.

At block 606, an MS may determine whether or not DSF occurs based on a downlink signaling failure counter (DSC), which is known in the art, is described, for example, in the document 3GPP TS 05.08, section 6.5, version 8.23.0. The DSC is initialized to a start value when the MS first camps on a cell. Thereafter, the DSC is incremented by one (e.g., may be limited to the start value) whenever a paging message from the serving cell is decoded correctly and decremented by four whenever a paging message is decoded in error. DSF occurs when the DSC reaches zero or below.

At block 608, the determination of a better cell (a target cell for reselection) is made based on the path loss criterion parameter C2, which is a function of C1 and other parameters described in, for example, the document 3GPP TS 05.08, section 6.4, version 8.23.0. A neighbor or non-serving cell is deemed to be better than the current serving cell if the C2 value of the non-serving cell is higher (i.e., better) than the C2 value of the current serving cell for at least five seconds.

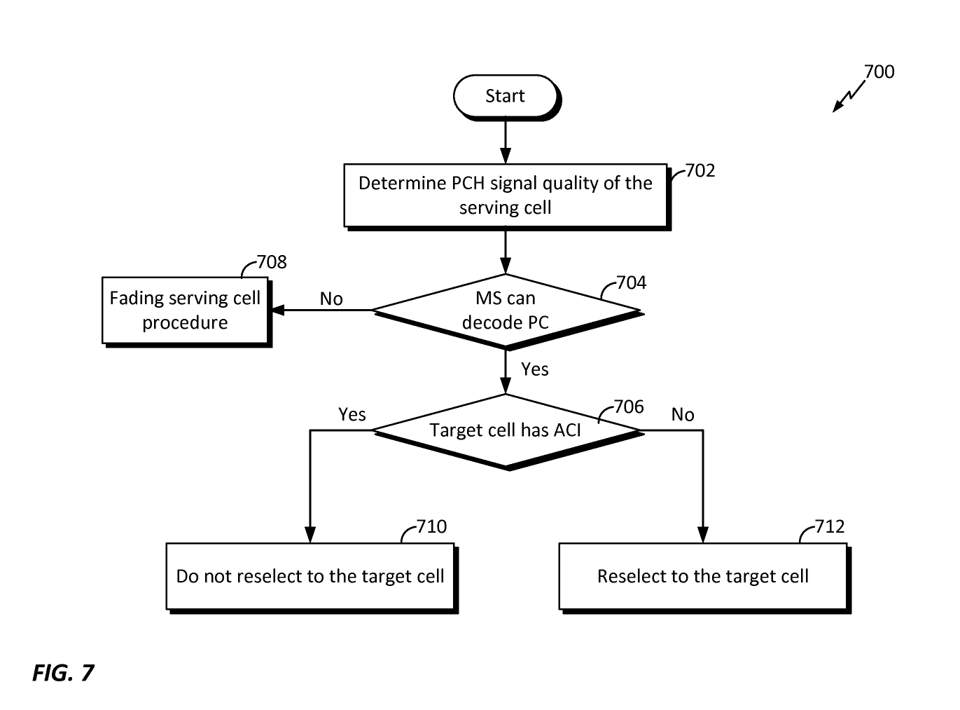

FIG. 7 is a diagram illustrating a cell reselection procedure 700 for reducing unnecessary cell reselection in accordance with aspects of the disclosure. For example, the reselection procedure 700 may be performed by any MS illustrated in FIGS. 1, 2, 9, and/or 10 at any of the cells illustrated in FIGS. 1 and/or 2. In one aspect of the disclosure, the reselection procedure 700 may be performed at block 604 of FIG. 6. At block 702, an MS determines the signal quality of the PCH of a serving cell. At block 704, if it is determined that the signal quality of the PCH has a level that allows the PCH to be decoded successfully by the MS (i.e., PCH has good or satisfactory signal quality), the procedure 700 proceeds to block 706; otherwise, it proceeds to block 708. In one aspect of the disclosure, the MS performs a fading serving cell procedure at block 708, which will be described in detail below.

At block 706, if it is determined that a target cell for reselection has ACI, the procedure 700 proceeds to block 710; otherwise, the procedure 700 proceeds to block 712. For example, the MS may determine the target cell based on the signal level quality of the respective ARFCNs assigned to the neighbor cells as described in relation to block 404 of FIG. 4. In addition, the MS may determine the ACI of the target call as described in relation to block 406 of FIG. 4. In C2-based reselection, for example, the target cell has a C2 value better than that of the current serving cell.

At block 710, if the PCH has good or satisfactory signal quality and the target cell has ACI, the MS does not reselect (avoid cell reselection) to the target cell. That is, the MS does not reselect to the target cell with a better C2 value but is interference limited (i.e., affected by ACI), even after a cell reselection timer has expired on the target cell. In an example, after the completion of a 5-second cell reselection timer, when a cell reselection procedure would otherwise be started, the MS checks whether the target cell is interference limited. For example, a cell is interference limited if the MS determines the presence of any cells with associated ARFCNs adjacent to the target cell's ARFCN, with a difference in signal level being less than or equal to a certain value (e.g., 10 dBm or other suitable values), in the BA list or a cell reselection measurement list. At block 712, if the target cell has no ACI, the MS may reselect to the target cell that has a better C2 value than the serving cell.

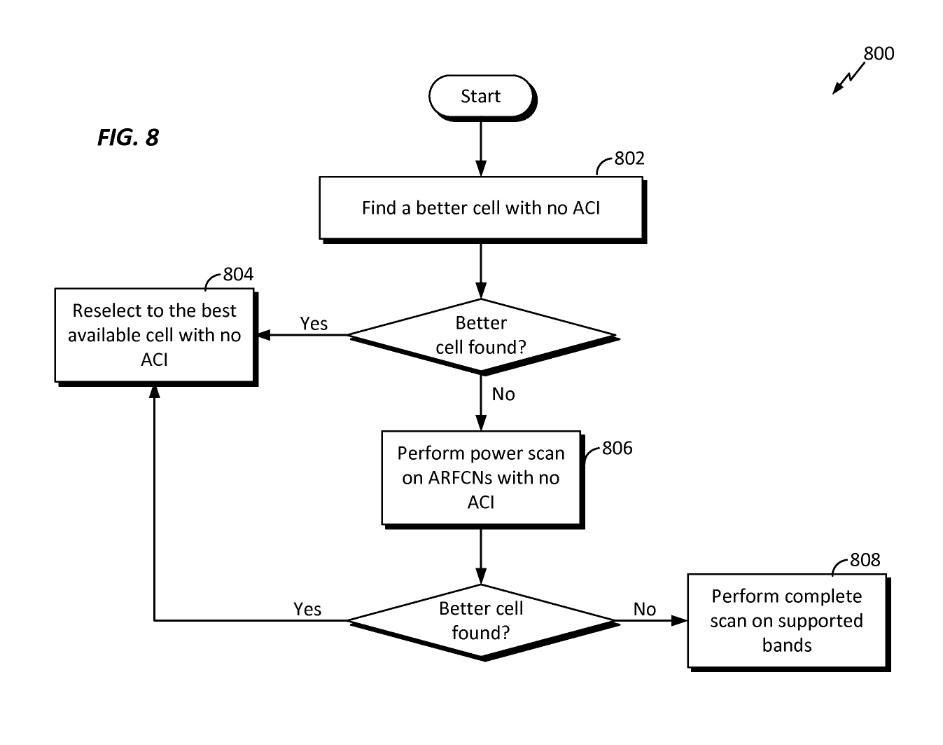

FIG. 8 is a diagram illustrating a cell reselection procedure 800 for reducing unnecessary cell reselection in accordance with aspects of the disclosure. For example, the reselection procedure 800 may be performed by any MS illustrated in FIGS. 1, 2, 9, and/or 10 at any of the cells illustrated in FIGS. 1 and/or 2. In one aspect of the disclosure, the MS may be the MS 236 of FIG. 2. In one aspect of the disclosure, the reselection procedure 800 may be performed at block 708 of FIG. 7. In an example, the MS may consider a serving cell as fading if the MS cannot decode the PCH from the serving cell. At block 802, when the serving cell is fading, the MS finds a better cell with no ACI for reselection. For example, a better cell may be a non-serving cell with a better C2 value than that of the current serving cell, in the BA list or cell reselection measurement list. If a better cell is found, the procedure 800 proceeds to block 804; otherwise, the procedure 800 proceeds to block 806. At block 804, the MS reselects to the best available cell, which is not having ACI and has a greater C2 value than the serving cell.

At block 806, if the available better cells include only cells that have ACI, then the MS performs a power scan to find other better cells, if available. In a power scan, the MS obtains received signal strength measurements for all ARFCNs of interest. The number of ARFCNs to scan is dependent on the specific frequency band(s) supported by the MS. The power scan produces a list of ARFCNs sorted based on their signal strength measurements. Then, the MS may attempt acquisition of the ARFCNs with no ACI in the list, one ARFCN at a time, to find a better cell with no ACI to camp on.

If the MS can find a better cell with no ACI, the procedure 800 proceeds to block 804; otherwise; the procedure proceeds to block 808. At block 808, because no suitable ARFCNs or cells are found during the power scan, the MS performs a complete scan on all the frequency bands supported by the MS. By doing so, the MS can find out any other valid ARFCNs to which it can do a reselection or cell selection. For each ARFCN found, the MS will try to decode the FCCH and SCH. After that MS will try to decode the BCCH and check whether the ARFCN is barred or not. For an ARFCN to be considered valid, its' signal level should be above −104 dBm for example. In addition, the MS still avoids ACI for valid ARFCN found.

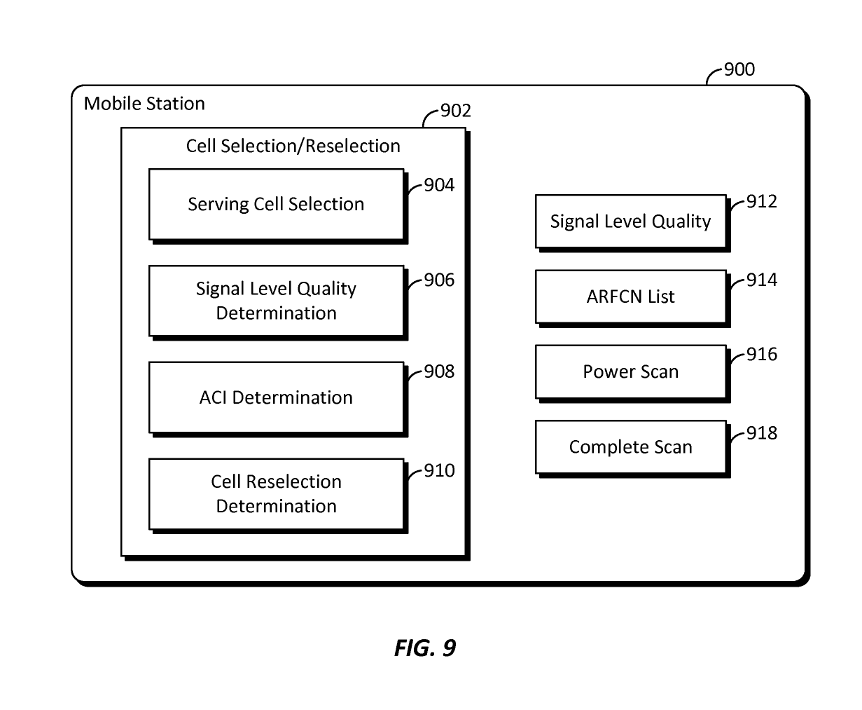

FIG. 9 is a block diagram illustrating an MS 900 configured to reduce unnecessary cell reselection in accordance with an aspect of the disclosure. For example, the MS 900 may be any MS illustrated in FIGS. 1, 2, and/or 10. The MS 900 includes a number of components that may be configured to perform the cell reselection procedures described in FIGS. 4 to 8 in any cells, for example, illustrated in FIGS. 1 and 2. The components of MS 900 may be implemented in software, firmware, hardware, or a combination thereof. The MS 900 includes a cell selection/reselection component 902 that may be configured to perform various cell selection/reselection functions or procedures, for example, described in relation to FIGS. 4 to 8. In one aspect of the disclosure, the cell selection/reselection component 902 includes a serving cell selection component 904, a signal level quality determination component 906, an ACI determination component 908, and a cell reselection determination component 910.

The serving cell selection component 904 may be configured to perform, for example, the functions described in relation to block 402 of FIG. 4 to find and camp on a serving cell. The signal level quality determination component 906 may be configured to perform, for example, the functions described in relation to block 404 of FIG. 4. In one aspect of the disclosure, the MS may utilize the signal level quality determination component 906 to determine the signal level quality 912 (or channel quality) of the ARFCNs of the serving cell and non-serving cells (neighbor cells). The ARFCNs of the cells may be kept in an ARFCN list 914. In one aspect of the disclosure, the ARFCN list 914 may be a BA list or a cell reselection measurement list.

The ACI determination component 908 may be configured to perform, for example, the functions described in relation to block 406 of FIG. 4. In one aspect of the disclosure, the MS 900 may utilize the ACI determination component 908 to determine the ACI in each of a number of cells, including the cells of the ARFCN list 914. For example, the MS 900 may determine the ACI based on a difference in signal level quality between an ARFCN of a first cell (e.g., a first neighbor cell) and an adjacent ARFCN of another cell (e.g., a second neighbor cell).

The cell reselection determination component 910 may be configured to perform the cell reselection functions and procedures described in FIGS. 4 and 6-8. In one aspect of the disclosure, if a serving cell is in good or satisfactory RF condition, and the MS is able to decode the PCH, the cell reselection determination component 910 does not reselect to a target cell that is suffering from ACI, even after a cell reselection timer has expired on the target cell. In another aspect of the disclosure, if the serving cell is fading, and if there are better neighbor cells, including cell neighbors that have adjacent channels (ARFCNs), then the cell reselection determination component 910 avoids reselection to a better cell with ACI, and reselects to the best available cell that has no ACI and a greater C2 value than the serving cell. In addition, if all the better cells of the BA list have ACI, then the MS 900 may utilize a power scan component 916 to find other better cells by performing a power scan. If no better ARFCNs or cells are found during the power scan, then the MS 900 may utilize a complete scan component 918 to perform a complete scan on all the frequency bands supported by the MS 900. Therefore, the MS 900 may find out other valid ARFCNs to which it can do a cell reselection/selection as described above.

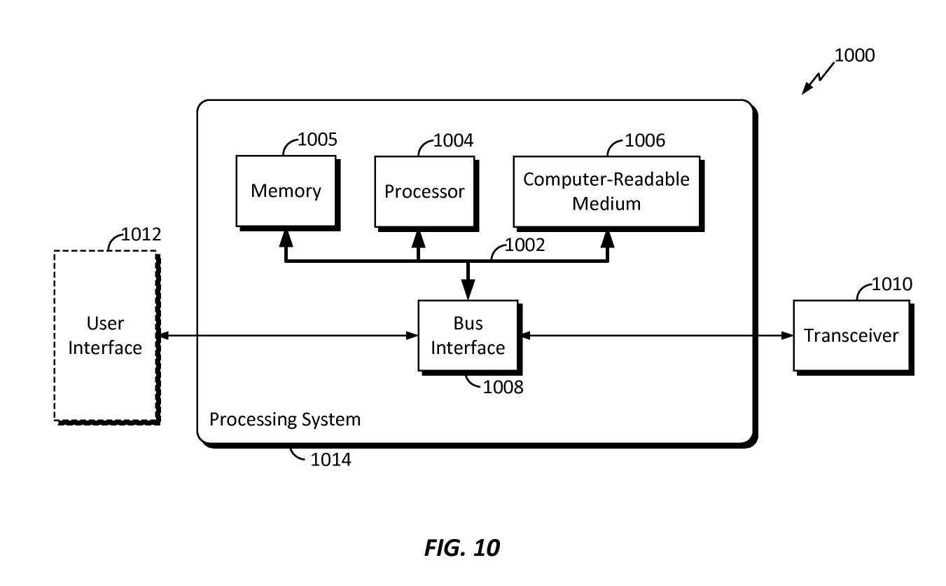

FIG. 10 is a block diagram illustrating an example of a hardware implementation for an apparatus 1000 employing a processing system 1014 in accordance with an aspect of the disclosure. In accordance with various aspects of the disclosure, an element, or any portion of an element, or any combination of elements may be implemented with a processing system 1014 that includes one or more processors 1004. For example, the apparatus 1000 may be an MS as illustrated in any one or more of FIGS. 1, 2, and/or 9. In an aspect of the disclosure, the apparatus 1000 may be an MS 900 of FIG. 9. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 1004, as utilized in an apparatus 1000, may be used to implement any one or more of the processes, procedures, or methods described and illustrated in FIGS. 4-8.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 links together various circuits or components including one or more processors (represented generally by the processor 1004), a memory 1005, computer-readable media (represented generally by the computer-readable medium 1006), and a SIM card 1011. The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010. The transceiver 1010 provides a means for communicating with various other apparatus over a transmission medium.

Depending upon the nature of the apparatus, a user interface 1012 (e.g., keypad, display, speaker, microphone, joystick, touchpad, touchscreen) may also be provided. The processor 1004 is responsible for managing the bus 1002 and general processing, including the execution of software 1007 stored on the computer-readable medium 306. The software 1007, when executed by the processor 1004, causes the processing system 1014 to perform the various cell selection/reselection functions and procedures described in FIGS. 4-8. The computer-readable medium 1006 may also be used for storing data that is manipulated by the processor 1004 when executing software.

One or more processors 1004 in the processing system may execute software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1006. The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

Several aspects of a telecommunications system have been presented with reference to a GERAN system. As those skilled in the art will readily appreciate, various aspects described throughout this disclosure may be extended to other telecommunication systems, network architectures and communication standards.

By way of example, various aspects may be extended to systems employing UMTS (FDD, TDD), Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication operable at a mobile station (MS), comprising:
determining a signal level quality for each of a plurality of cells comprising a serving cell and a plurality of neighbor cells;
determining adjacent channel interference (ACI) in each of the plurality of cells in a same public land mobile network (PLMN); and
performing a cell reselection procedure based on a respective signal level quality and ACI of the plurality of cells in the same PLMN.

2. The method of claim 1, further comprising:
determining the signal level quality comprises determining a signal quality of a paging channel (PCH) of the serving cell; and
if the signal quality of the PCH has a level sufficient to be decoded by the MS, avoiding cell reselection to the neighbor cell that has ACI and a better signal level quality than that of the serving cell.

3. The method of claim 1, wherein determining the ACI comprises:
determining a difference in signal level quality between a first channel of a first cell and a second channel of a second cell of the plurality of cells, wherein the first channel and the second channel are neighbor absolute radio-frequency channel numbers.

4. The method of claim 1, wherein determining the ACI comprises:
determining a difference in signal level quality between a first channel of a first cell and a second channel of a second cell of the plurality of cells,
wherein the first channel and the second channel are included in a Broadcast Control Channel (BCCH) allocation list or a cell reselection measurement list of the MS.

5. The method of claim 4, wherein determining the ACI comprises:
determining the ACI is present when the difference in signal level quality between the first channel and the second channel is less than or equal to 10 dBm.

6. The method of claim 1, further comprising:
the plurality of neighbor cells comprise a first neighbor cell and a second neighbor cell, both with a signal level quality better than that of the serving cell; and
if the first neighbor cell has ACI, avoiding cell reselection to the first neighbor cell and reselecting to the second neighbor cell, wherein the second neighbor cell has no ACI.

7. The method of claim 1, wherein the cell reselection procedure comprises:
if the serving cell is fading and none of the neighbor cells with no ACI has signal level quality better than that of the serving cell, performing a power scan on a plurality of channels with no ACI to find a target cell with a signal level quality better than that of the serving cell.

8. The method of claim 7, wherein the cell reselection procedure comprises:
if no target cell is found by the power scan, performing a complete scan on all frequency bands supported by the MS to find a target cell with no ACI having a signal level quality better than that of the serving cell.

9. A mobile station (MS), comprising:
a signal level quality determination component configured to determine a signal level quality for each of a plurality of cells comprising a serving cell and a plurality of neighbor cells;
an adjacent channel interference (ACI) determination component configured to determine ACI in each of the plurality of cells in a same public land mobile network (PLMN); and
a cell reselection determination component configured to perform a cell reselection procedure based on a respective signal level quality and ACI of the plurality of cells in the same PLMN.

10. The MS of claim 9, further comprising:
the signal level quality determination component is configured to determine a signal quality of a paging channel (PCH) of the serving cell; and
if the signal quality of the PCH has a level sufficient to be decoded by the MS, the cell reselection determination component is configured to avoid cell reselection to the neighbor cell that has ACI and a better signal level quality than that of the serving cell.

11. The MS of claim 9, wherein the ACI determination component is configured to:
determine a difference in signal level quality between a first channel of a first cell and a second channel of a second cell of the plurality of cells, wherein the first channel and the second channel are neighbor absolute radio-frequency channel numbers.

12. The MS of claim 9, wherein the ACI determination component is configured to:
determine a difference in signal level quality between a first channel of a first cell and a second channel of a second cell of the plurality of cells,
wherein the first channel and the second channel are included in a Broadcast Control Channel (BCCH) allocation list or a cell reselection measurement list of the MS.

13. The MS of claim 12, wherein the ACI determination component is configured to:
determine the ACI is present when the difference in signal level quality between the first channel and the second channel is less than or equal to 10 dBm.

14. The MS of claim 9, further comprising:
the plurality of neighbor cells comprise a first neighbor cell and a second neighbor cell, both with a signal level quality better than that of the serving cell; and
if the first neighbor cell has ACI, the cell reselection determination component is configured to avoid cell reselection to the first neighbor cell and reselect to the second neighbor cell, wherein the second neighbor cell has no ACI.

15. The MS of claim 9, further comprising a power scan component configured to:
if the serving cell is fading and none of the neighbor cells with no ACI has signal level quality better than that of the serving cell, perform a power scan on a plurality of channels with no ACI to find a target cell with a signal level quality better than that of the serving cell.

16. The MS of claim 15, further comprising a complete scan component configured to:
if no target cell is found by the power scan, perform a complete scan on all frequency bands supported by the MS to find a target cell with no ACI having a signal level quality better than that of the serving cell.

17. A mobile station (MS), comprising:
means for determining a signal level quality for each of a plurality of cells comprising a serving cell and a plurality of neighbor cells;
means for determining adjacent channel interference (ACI) in each of the plurality of cells in a same public land mobile network (PLMN); and
means for performing a cell reselection procedure based on a respective signal level quality and ACI of the plurality cells in the same PLMN.

18. The MS of claim 17, further comprising:
means for determining a signal quality of a paging channel (PCH) of the serving cell; and
if the signal quality of the PCH has a level sufficient to be decoded by the MS, means for avoiding cell reselection to the neighbor cell that has ACI and a better signal level quality than that of the serving cell.

19. The MS of claim 17, wherein the means for determining the ACI is configured to:
determine a difference in signal level quality between a first channel of a first cell and a second channel of a second cell of the plurality of cells, wherein the first channel and the second channel are neighbor absolute radio-frequency channel numbers.

20. The MS of claim 17, wherein the means for determining the ACI is configured to:
determine a difference in signal level quality between a first channel of a first cell and a second channel of a second cell of the plurality of cells,
wherein the first channel and the second channel are included in a Broadcast Control Channel (BCCH) allocation list or a cell reselection measurement list of the MS.

21. The MS of claim 20, wherein the means for determining the ACI is configured to:
determine the ACI is present when the difference in signal level quality between the first channel and the second channel is less than or equal to 10 dBm.

22. The MS of claim 17, further comprising:
the plurality of neighbor cells comprise a first neighbor cell and a second neighbor cell, both with a signal level quality better than that of the serving cell; and
if the first neighbor cell has ACI, means for avoiding cell reselection to the first neighbor cell and reselecting to the second neighbor cell, wherein the second neighbor cell has no ACI.

23. The MS of claim 17, wherein the cell reselection procedure comprises:
if the serving cell is fading and none of the neighbor cells with no ACI has signal level quality better than that of the serving cell, performing a power scan on a plurality of channels with no ACI to find a target cell with a signal level quality better than that of the serving cell.

24. The MS of claim 23, wherein the cell reselection procedure comprises:
if no target cell is found by the power scan, performing a complete scan on all frequency bands supported by the MS to find a target cell with no ACI having a signal level quality better than that of the serving cell.

25. A computer-readable medium comprising code for causing a mobile station (MS) to:
determine a signal level quality for each of a plurality of cells comprising a serving cell and a plurality of neighbor cells;
determine adjacent channel interference (ACI) in each of the plurality of cells in a same public land mobile network (PLMN); and
perform a cell reselection procedure based on a respective signal level quality and ACI of the plurality of cells in the same PLMN.

26. The computer-readable medium of claim 25, further comprising code for causing the MS to:
determine a signal quality of a paging channel (PCH) of the serving cell; and
if the signal quality of the PCH has a level sufficient to be decoded by the MS, avoid cell reselection to the neighbor cell that has ACI and a better signal level quality than that of the serving cell.

27. The computer-readable medium of claim 25, wherein for determining the ACI, the code causes the MS to:
determine a difference in signal level quality between a first channel of a first cell and a second channel of a second cell of the plurality of cells, wherein the first channel and the second channel are neighbor absolute radio-frequency channel numbers.

28. The computer-readable medium of claim 25, further comprising code for causing the MS to:
the plurality of neighbor cells comprise a first neighbor cell and a second neighbor cell, both with a signal level quality better than that of the serving cell; and
if the first neighbor cell has ACI, avoid cell reselection to the first neighbor cell and reselect to the second neighbor cell, wherein the second neighbor cell has no ACI.

29. The computer-readable medium of claim 25, wherein the cell reselection procedure comprises:
if the serving cell is fading and none of the neighbor cells with no ACI has signal level quality better than that of the serving cell, performing a power scan on a plurality of channels with no ACI to find a target cell with a signal level quality better than that of the serving cell.

30. The computer-readable medium of claim 29, wherein the cell reselection procedure comprises:
if no target cell is found by the power scan, performing a complete scan on all frequency bands supported by the MS to find a target cell with no ACI having a signal level quality better than that of the serving cell.
